(19) United States
(12) Patent Application Publication
(10) Pub. No.: US 2013/0169883 A1
(43) Pub. Date: Jul. 4, 2013

(54) AV EQUIPMENT AND INITIALIZATION METHOD OF THE EQUIPMENT

(71) Applicant: Masahiro SEO, Osaka (JP)

(72) Inventor: Masahiro SEO, Osaka (JP)

(73) Assignee: Panasonic Corporation, Osaka (JP)

(21) Appl. No.: 13/592,479

(22) Filed: Aug. 23, 2012

(30) Foreign Application Priority Data
Dec. 28, 2011 (JP) 2011-288544

(51) Int. Cl. H04N 5/44

(52) U.S. Cl. 348/734; 348/E05.096

(57) ABSTRACT

AV equipment enables individual initial setting for each user utilizing near field communication without requiring any cumbersome operation. A determiner determines whether or not identification information of a portable device obtained by a near field communicator is identical to registered identification information to detect the registered portable device, which is located close to the AV equipment. A setter reads initial setting detail corresponding to the portable device detected by the determiner from the memory, and sets the read initial setting detail to the AV equipment. In searching the portable device, an output power controller initially sets the output power to an initial value, and gradually increases the output power while the registered portable device is not detected.

### CROSS-REFERENCE TO RELATED APPLICATION

This application claims priority to Japanese Patent Application No. 2011-288544 filed on Dec. 28, 2011, the disclosure of which including the specification, the drawings, and the claims is hereby incorporated by reference in its entirety.

### BACKGROUND

The present disclosure relates to AV equipment, and more particularly to AV equipment such as TVs having a near field communication function.

A technique is shown, which allows a viewer to recognize a mobile phone existing within a viewable range (i.e., a position capable of sending an operation signal), where a mobile phone capable of communications is detected in AV equipment such as a TV, by displaying, on a display of the AV equipment, identification image corresponding to an identifier recorded in the AV equipment in response to an identifier (ID) of the detected mobile phone. (See, for example, Japanese Patent Publication No. 2011-61745.)

### SUMMARY

When AV equipment is powered on, for example, the channel, volume, and play position of recorded contents are set as initial settings. If the AV equipment is shared by a plurality of users such as a family, such initial settings are preferably made for each user. However, a single remote control is usually attached to AV equipment, which requires cumbersome operation in power-on if initial settings are individually made for each user.

The present disclosure enables individual initial settings for each user in AV equipment utilizing near field communication without requiring any cumbersome operation.

According to an aspect of the present disclosure, AV equipment includes a near field communicator configured to perform near field communication and to obtain identification information of a portable device with which the near field communication has established communication; an output power controller configured to control output power of the near field communicator; a memory configured to store registered identification information which is identification information of a portable device registered in the AV equipment, and initial setting detail of the AV equipment corresponding to the registered portable device; a determiner configured to detect the registered portable device, which is located close to the AV equipment, by determining whether or not the identification information obtained by the near field communicator is identical to the registered identification information stored in the memory; and a setter configured to read the initial setting detail corresponding to the portable device detected by the determiner from the memory when the AV equipment is powered on, and to set the read initial setting detail to the AV equipment. Search of the portable device located close to the AV equipment is executed by operation of the near field communicator, the output power controller, and the determiner. In the search, the output power controller initially sets the output power to an initial value, and gradually increases the output power while the registered portable device is not detected.

According to another aspect, a method of initializing AV equipment, which includes a near field communicator configured to perform near field communication and to obtain identification information of a portable device with which the near field communicator has established communication, and a memory configured to store registered identification information which is identification information of a portable device registered in the AV equipment, and initial setting detail of the AV equipment corresponding to the registered portable device. The method includes detecting the registered portable device, which is located close to the AV equipment, by determining whether or not the identification information obtained by the near field communicator is identical to the registered identification information stored in the memory; and reading the initial setting detail corresponding to the portable device detected in the detecting from the memory when the AV equipment is powered on, and setting the read initial setting detail to the AV equipment. In the detecting, output power of the near field communicator is initially set to an initial value, and gradually increases the output power while the registered portable device is not detected.

According to these aspects, the registered portable device, which is located close to the AV equipment, is detected by determining whether or not the identification information of the portable device obtained by the near field communicator is identical to the registered identification information stored in the memory. When the AV equipment is powered on, the initial setting detail corresponding to the detected portable device is read from the memory and set. With this configuration, when the AV equipment is powered on, the user who has powered on is identified by the identification information of the portable device owned by the user, and initial settings corresponding to the user can be made. Furthermore, the output power of the near field communicator is initially set to the initial value, and is gradually increased while the registered portable devices is not detected. This reliably identifies the user who is closer to the AV equipment as the user who has powered on the AV equipment.

According to the present disclosure, when powered on, AV equipment reliably identifies the user who has powered on the AV equipment, and makes initial settings corresponding to the identified user.

### BRIEF DESCRIPTION OF THE DRAWINGS

FIG. 1 is a block diagram illustrating the configuration of a television as an example of AV equipment according to an embodiment.

FIGS. 2A-2D illustrate an example of what are stored in memories. FIG. 2A illustrates what are stored in a registered user address memory. FIG. 2B illustrates what are stored in an initial channel memory. FIG. 2C illustrates what are stored in a resume memory. FIG. 2D illustrates what are stored in an initial volume memory.

FIG. 3 is a view illustrating example search zones according to output power.

FIG. 4 is a flow chart illustrating an initialization method of a television according to an embodiment.

FIG. 5 illustrates sequence of communication between a television and a terminal.

### DETAILED DESCRIPTION

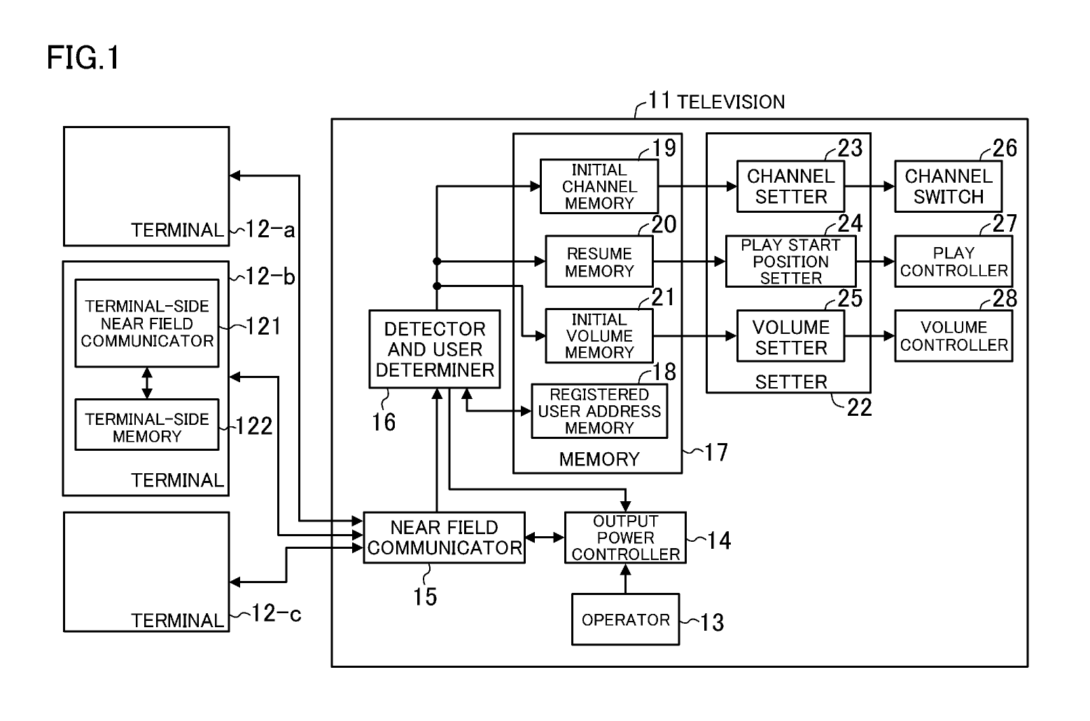

FIG. 1 is a block diagram illustrating the configuration of a television as an example of AV equipment according to an embodiment. FIG. 1 also illustrates a plurality of portable devices located close to the television.

In FIG. 1, a television 11 includes a near field communicator 15 performing near field communication using, for example, a Bluetooth (registered trademark) function. Portable terminal devices (hereinafter referred to as “terminals” as appropriate) 12-a, 12-b, and 12-c are, for example, mobile phones and high function mobile phones (smart phones), which can communicate with the television 11 by, for example, the Bluetooth function.

The television 11 further includes an operator 13, an output power controller 14 controlling the output power of the near field communicator 15, a detector and user determiner 16 as a determiner detecting a terminal located close to the television 11 and determining a user who has operated the television 11, a memory 17, a setter 22, a channel switch 26, a play controller 27, and a volume controller 28. In this embodiment, the television 11 has a recording function.

The operator 13 allows a user to operate the television 11. The operator 13 may be, for example, a main power switch provided with the body of the television 11, or may be controlled by an attached infrared remote control.

The memory 17 stores registered identification information which is the identification information of terminals registered in the television 11, and the initial setting details of the television 11 corresponding to registered terminals. In this embodiment, user addresses, which are unique numbers of the terminals having a near field communication function, are used as the identification information of the terminals. Specifically, the memory 17 includes a registered user address memory 18 storing the user addresses of the registered terminals. In this embodiment, setting of channel selection, the play position of recorded contents, and the volume are stored as the initial settings of the television 11. Specifically, the memory 17 includes an initial channel memory 19, a resume memory 20, and an initial volume memory 21, each of which stores initial setting details corresponding to the registered user addresses.

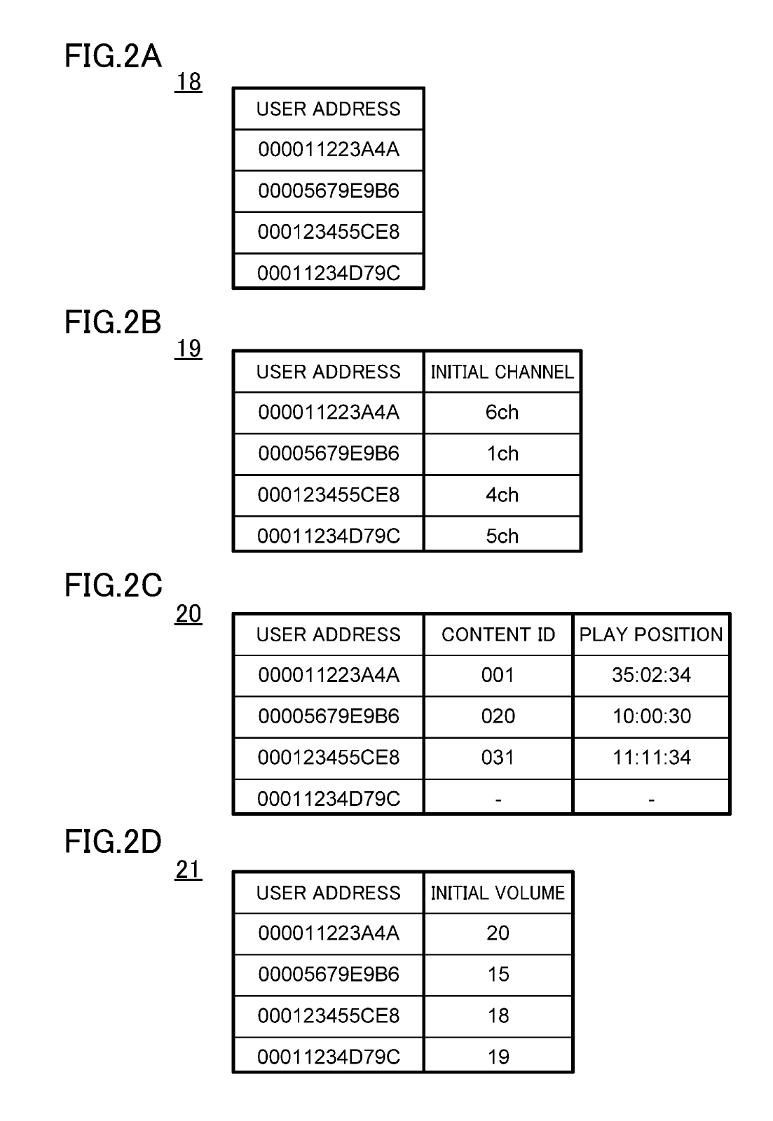

FIGS. 2A-2D illustrate an example of what are stored in the memory 17. FIG. 2A illustrates what are stored in the registered user address memory 18. The registered user addresses are stored in the memory 18. In this embodiment, Bluetooth addresses which are values of 12 bytes are used as the user addresses. The user addresses may be registered in, for example, setting the television 11, or purchasing a new portable device, etc. FIG. 2B illustrates what are stored in the initial channel memory 19. An initial channel for each user address is stored. FIG. 2C illustrates what are stored in the resume memory 20. A content ID and the play position of contents for each user address are stored. However, no content ID and no play position are stored for the user address 00011234D79C. FIG. 2D illustrates what are stored in the initial volume memory 21. An initial volume for each user address is stored.

The registered user address memory 18, the initial channel memory 19, the resume memory 20, and the initial volume memory 21 may be formed individually; or all or part of them may be integrated as a single memory.

The setter 22 reads initial setting details of a terminal detected by the detector and user determiner 16 from the memory 17, and sets the initial setting details to the television 11. A channel setter 23 instructs the channel switch 26 to set a channel upon receipt of the initial channel information read from the initial channel memory 19. A play start position setter 24 instructs the play controller 27 to set resume information upon receipt of resume information, i.e., the content ID and the play position, read from the resume memory 20. A volume setter 25 instructs the volume controller 28 to set a volume upon receipt of the initial volume information read from the initial volume memory 21.

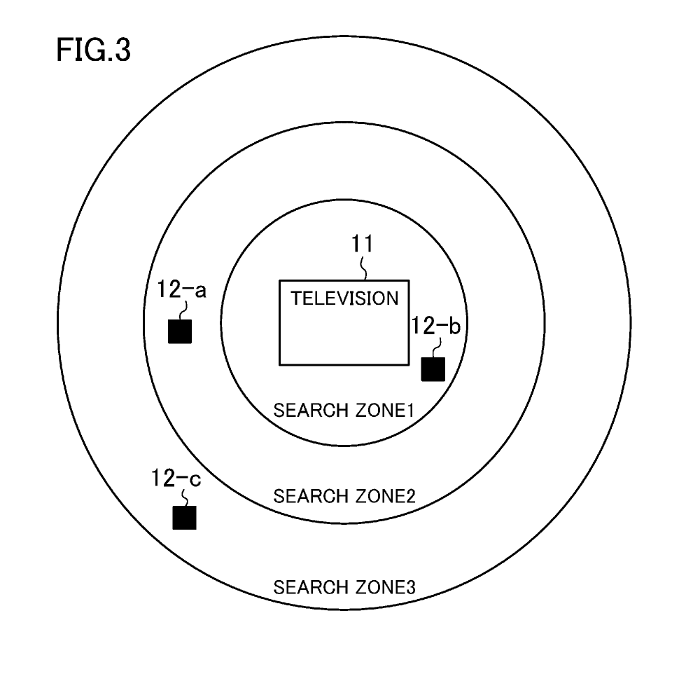

The output power controller 14 can gradually control the output power of the near field communicator 15. In this embodiment, the output power controller 14 shifts the output power of the near field communicator 15 among three levels. FIG. 3 is a schematic view illustrating example search zones according to the levels of the output power. In FIG. 3, search zones 1, 2, and 3 correspond to the times when the output power is small, medium, and great, respectively. In this embodiment, when a terminal located close to the television 11 is searched, the output power of the near field communicator 15 is initially set to an initial value, which corresponds to the search zone 1, and is then gradually increased while the registered terminal is not detected.

Each of terminals 12-a, 12-b, and 12-c includes a terminal-side near field communicator 121 performing near field communication using a Bluetooth function, and a terminal-side memory 122 storing user addresses. In FIG. 1, the internal configurations of the terminals 12-a and 12-c are not shown.

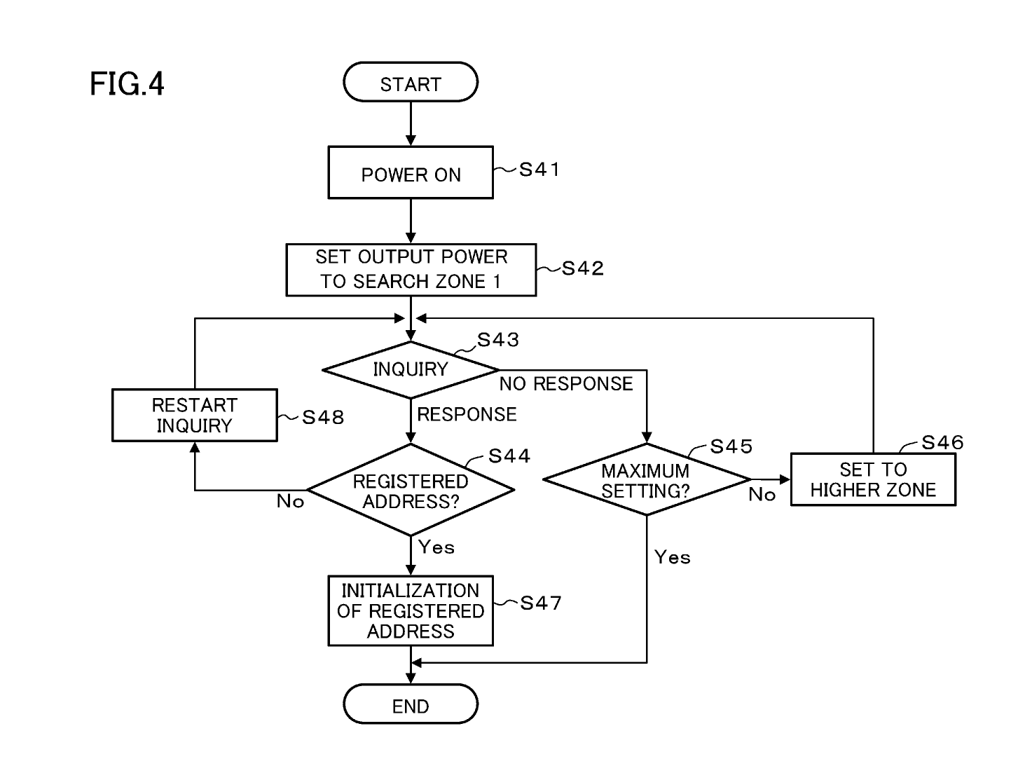

An initialization method of the television 11 according to this embodiment will be described with reference to the flow chart of FIG. 4. In this embodiment, the initial channel memory 19 stores unique channel information set for each registered user. The initial volume memory 21 stores unique volume information set for each registered user. Once a registered user is detected, the resume memory 20 updates the resume information of the registered user every time when recorded contents are played. That is, the resume memory 20 stores the content ID and the play position of the last recorded contents viewed by the registered user.

A user operates the operator 13 to power on the television 11 (S41). When the television 11 is powered on, first, the output power controller 14 sets the output power corresponding to the search zone 1 to the near field communicator 15 (S42).

Then, the output power controller 14 instructs the near field communicator 15 to issue (i.e., broadcast) an inquiry to many and unspecified terminals having a near field communication function. In order to measure the duration time for the inquiry issued by the near field communicator 15, the output power controller 14 starts a timer at the start of issuing the inquiry. The inquiry from the near field communicator 15 continues until the near field communicator 15 has received a response message from any one of the terminals, or until a predetermined time (e.g., 5 seconds) has passed (S43).

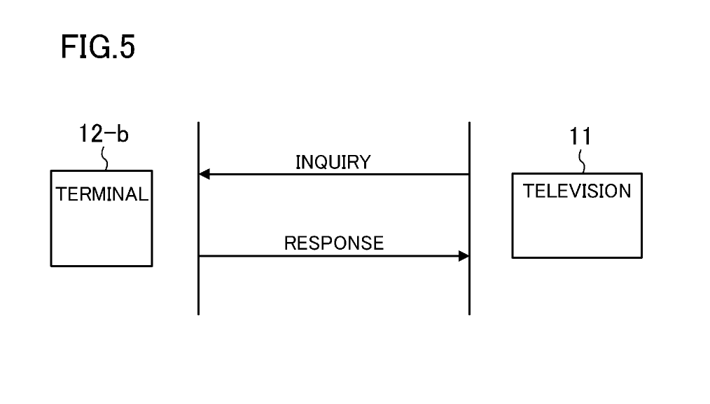

FIG. 5 illustrates sequence of communication between a television and a terminal. FIG. 5 illustrates that the television 11 makes inquiry using near field communication, and, for example, that the terminal 12-b responds to the inquiry. The terminal 12-b (as well as the other terminals 12-a and 12-c) sends the response message to the near field communicator 15 upon receipt of the inquiry from the near field communicator 15. The response message to be sent includes a user address (herein a Bluetooth address) for identifying an individual terminal. The user address is held in the terminal-side memory 122. The terminal-side near field communicator 121 reads the user address from the terminal-side memory 122, includes the user address in the response message, and sends the response message.

The near field communicator 15 stops the issue of the inquiry upon receipt of the response message from the terminal-side near field communicator 121 (“RESPONSE” in S43), analyzes the contents of the received response message, and transfers the user address included in the response message to the detector and user determiner 16. The detector and user determiner 16 determines whether or not the transferred user address is identical to a user address registered in the registered user address memory 18 (S44).

The detector and user determiner 16 transfers the user address to the memory 17 when it has determined that the transferred user address is identical to a registered user address (“YES” in S44). In addition, the detector and user determiner 16 instructs the output power controller 14 to stop the inquiry. Upon receipt of the instructions, the output power controller 14 stops the inquiry from the near field communicator 15.

When the user address is transferred to the memory 17, the initial setting details corresponding to the user address is read, and transferred to the setter 22. Specifically, the initial channel information is read from the initial channel memory 19, and transferred to the channel setter 23. The resume information, i.e., the content ID and the play position are read from the resume memory 20, and transferred to the play start position setter 24. The initial volume information is read from the initial volume memory 21, and transferred to the volume setter 25.

The setter 22 makes initial settings corresponding to the registered user address in accordance with the transferred initial setting details. Specifically, the channel setter 23 instructs the channel switch 26 to change the channel upon receipt of the channel information. The play start position setter 24 instructs the play controller 27 to change the resume information upon receipt of the resume information. The volume setter 25 instructs the volume controller 28 to change the setting of the volume upon receipt of the volume information (S47).

On the other hand, in the step S44, when it has been determined that the transferred user address is not identical to any registered user address and is a non-registered address (“NO” in S44), the detector and user determiner 16 notifies the output power controller 14 that the transferred user address is a non-registered address. Upon receipt of the notice, the output power controller 14 instructs the near field communicator 15 to restart stopped issuance of the inquiry, thereby restarting the issuance of the inquiry (S48).

In the step S43, if the output power controller 14 has not received any response message from a registered user address within the predetermined time measured by the timer (“NO RESPONSE” in S43), the output power controller 14 determines whether or not the present output power reaches a predetermined upper limit (S45). If the present output power does not reach the upper limit (“NO” in S45), the output power controller 14 instructs the near field communicator 15 to set the output power one level higher (S46). If the present output power corresponds to the search zone 1, the near field communicator 15 sets the output power to correspond to the search zone 2. The output power controller 14 resets the timer to 0 second, and restarts the search for the registered user address in the search zone 2 as described above.

If no registered user address is detected even in the search zone 2, the output power is set to correspond to the search zone 3, i.e., the upper limit. If no registered user address is detected even in the search zone 3 (“YES” in S45), the output power controller 14 instructs the near field communicator 15 to stop the inquiry.

As such, in this embodiment, the output power of the near field communication is initially set to the initial value, and the output power is gradually increased to expand the range of the search zone. This reliably identifies the user located closest to the television 11 as the user who has made operation. Furthermore, even a terminal located out of the search zone 1 can be detected.

While the initial channel memory 19 stores unique channel information, for example, the channel information may be updated every time when the display is changed since the registered terminal is detected, and the channel viewed last may be stored as the channel information of the user address. Similarly, while the initial volume memory 21 stores unique volume information, for example, the volume information may be updated every time when the volume is changed since the registered terminal is detected, and the volume set last may be stored as the volume information of the user address.

While in this embodiment, the television 11 has the recording function, the television 11 itself may not necessarily have the recording function. In this case, for example, resume play of DVD or BD contents recorded by other equipment may be initialized similar to the above-described embodiment.

While in this embodiment, the volume, the channel selection, and the play position of recorded contents are initialized, not all of them may be necessarily initialized, but part of them may be initialized. Other setting details may be also initialized.

While in this embodiment, the output power is set to three levels, the levels are not limited thereto.

The upper limit of the output power may be a predetermined fixed value, or may be set by a user from the outside of the television 11. The user may input the width of the room for viewing the contents when, for example, setting the television 11, thereby automatically setting the upper limit of the output power.

In a search zone, if a plurality of registered terminals are detected, the terminal for reading the initial settings may be determined in accordance with predetermined priority. For example, the user may set the priority such as 1) grand mother, 2) father, and 3) child. Alternatively, the television 11 may automatically determine the priority in accordance with the frequency of viewing.

While in the flow chart of FIG. 4, the registered terminal is searched after powering on the television 11, the order is not limited thereto. For example, the registered terminal may be searched at standby of the television 11, and the initial settings corresponding to the registered terminal detected at standby may be made when powered on. This largely shortens the time from power-on to the initialization. Where the registered terminal is searched at standby, search is preferably performed in, for example, predetermined intervals in view of power consumption.

While in this embodiment, the television has been described as an example of AV equipment, the equipment is not limited thereto. The AV equipment may be, for example, a recorder which receives and records digital broadcast. While Bluetooth is used as an example of near field communication, the communication is not limited thereto. Where home use is assumed, no problem arises in near field communication capable of communication at a distance of about 10 m.

In the present disclosure, when AV equipment is powered on, a user who has powered on is identified, and initial settings corresponding to the identified user is made. Therefore, the present disclosure is useful for improving the convenience of televisions, recorders, etc.

What is claimed is:

1. AV equipment comprising:
a near field communicator configured to perform near field communication and to obtain identification information of a portable device with which the near field communicator has established communication;
an output power controller configured to control output power of the near field communicator;
a memory configured to store registered identification information which is identification information of a portable device registered in the AV equipment, and initial setting detail of the AV equipment corresponding to the registered portable device;
a determiner configured to detect the registered portable device, which is located close to the AV equipment, by determining whether or not the identification information obtained by the near field communicator is identical to the registered identification information stored in the memory; and
a setter configured to read the initial setting detail corresponding to the portable device detected by the determiner from the memory when the AV equipment is powered on, and to set the read initial setting detail to the AV equipment, wherein
search of the portable device located close to the AV equipment is executed by operation of the near field communicator, the output power controller, and the determiner, and
in the search, the output power controller initially sets the output power to an initial value, and gradually increases the output power while the registered portable device is not detected.

2. The AV equipment of claim 1, wherein
the output power controller stops the output power in the search if the output power reaches a predetermined upper limit as long as the registered portable device is not detected.

3. The AV equipment of claim 2, wherein
the predetermined upper limit is set by a user from an outside of the AV equipment.

4. The AV equipment of claim 1, wherein
the output power controller stops the output power when the registered portable device has been detected in the search.

5. The AV equipment of claim 1, wherein
the search is executed when the AV equipment is powered on.

6. The AV equipment of claim 1, wherein
the search is executed at standby of the AV equipment.

7. The AV equipment of claim 1, wherein
when two or more of the registered portable device have been detected, the determiner determines the portable device of which initial setting detail is to be read in accordance with predetermined priority.

8. The AV equipment of claim 1, wherein
the initial setting detail includes at least one of setting of a volume, setting of channel selection, or setting of a play position of recorded contents.

9. A method of initializing AV equipment, the AV equipment including
a near field communicator configured to perform near field communication and to obtain identification information of a portable device with which the near field communicator has established communication, and
a memory configured to store registered identification information which is identification information of a portable device registered in the AV equipment, and initial setting detail of the AV equipment corresponding to the registered portable device,
the method comprising:
detecting the registered portable device, which is located close to the AV equipment, by determining whether or not the identification information obtained by the near field communicator is identical to the registered identification information stored in the memory; and
reading the initial setting detail corresponding to the portable device detected in the detecting from the memory when the AV equipment is powered on, and setting the read initial setting detail to the AV equipment, wherein
in the detecting, output power of the near field communicator is initially set to an initial value, and is gradually increased while the registered portable device is not detected.
